(19) United States
(12) Patent Application Publication
(10) Pub. No.: US 2025/0317210 A1
(43) Pub. Date: Oct. 9, 2025

(54) PHOTONICS TRANSCEIVER INCLUDING A LITHIUM-CONTAINING TRANSMITTER

(71) Applicant: HyperLight Corporation, Cambridge, MA (US)

(72) Inventor: Mian Zhang, Cambridge, MA (US)

(21) Appl. No.: 19/088,802

(22) Filed: Mar. 24, 2025

Related U.S. Application Data
(60) Provisional application No. 63/570,134, filed on Mar. 26, 2024.

(51) Int. Cl. H04B 10/40; G02B 6/42; H04B 10/50; H04B 10/516; H04B 10/61

(52) U.S. Cl. CPC H04B 10/40; G02B 6/4204; H04B 10/505; H04B 10/516; H04B 10/61

(57) ABSTRACT

A transceiver including an electronics integrated circuit (EIC), a photonics receiver integrated circuit (photonics RIC), a photonics transmitter integrated circuit (photonics TIC), and an interposer. The photonics RIC and TIC are each electrically coupled with the EIC. The photonics TIC is separate from the photonics RIC and includes at least one optical structure having a thin film lithium-containing (TFLC) electro-optic material. The interposer is coupled with the EIC, the photonics RIC, and the photonics TIC. The interposer is configured to route at least one of electrical or optical signals between at least two of the photonics RIC, the photonics TIC, or the EIC.

### CROSS REFERENCE TO OTHER APPLICATIONS

This application claims priority to U.S. Provisional Patent Application No. 63/570,134 entitled PHOTONICS TRANSCEIVER INCLUDING A LITHIUM-CONTAINING TRANSMITTER filed Mar. 26, 2024 which is incorporated herein by reference for all purposes.

### BACKGROUND OF THE INVENTION

A conventional integrated optical transceiver generally includes a heterogeneous photonics integrated circuit (PIC) and an electronic IC (EIC). The EIC includes send and receive electronics that are typically interleaved and connect to the heterogeneous PIC. The heterogeneous PIC typically includes a silicon photonics base, a transmitter portion, and a receiver portion. The transmitter (send) and receiver (receive) portions of the heterogeneous PIC are generally formed of different materials and are integrated on the silicon photonics base. For example, the receiver portion may include a photodiode and associated electronics. Thus, the receiver portion detects optical signals arriving at the heterogeneous PIC via the photodiode and converts the optical signals to electrical signals. These electrical signals are provided from the heterogeneous PIC to the EIC. The transmitter portion of the heterogeneous PIC is coupled to or includes a light source, such as a laser. The transmitter portion also includes one or more modulators, which may be integrated with the laser. Electrical signals are provided from the EIC to the transmitter portion of the heterogeneous PIC and converted to optical signals using the modulators.

The heterogeneous PIC is also coupled to a fiber array. The fiber array includes optical fibers that carry optical signals to the heterogeneous PIC (i.e. to the receiver portion) and from the heterogeneous PIC (i.e. from the transmitter portion). Typically, the fibers carrying optical signals to the PIC are interleaved with fibers carrying optical signals transmitted by the heterogeneous PIC. Similarly, send and receive electronics for the EIC are typically interleaved.

In a manner similar to other electronics, heterogeneous integration in the heterogeneous PIC provides multiple complementary functions that might not be possible using a single material system. It is also believed that heterogeneous integration reduces cost and allows for more compact systems while maintaining performance. However, improvements in optical transceivers are still desired.

### BRIEF DESCRIPTION OF THE DRAWINGS

Various embodiments of the invention are disclosed in the following detailed description and the accompanying drawings.

FIG. 1 depicts a block diagram of an embodiment of a heterogeneous transceiver including a thin film lithium-containing transmitter integrated circuit.

FIG. 2 depicts an embodiment of a thin film lithium-containing transmitter integrated circuit usable in a heterogeneous transceiver.

FIG. 3 depicts an embodiment of a thin film lithium-containing transmitter integrated circuit usable in a heterogeneous transceiver.

FIGS. 4A-4B depict an embodiment of a portion of a thin film lithium-containing transmitter integrated circuit usable in a heterogeneous transceiver.

FIG. 5 depicts an embodiment of a portion of a heterogeneous transceiver including a thin film lithium-containing transmitter integrated circuit.

FIG. 6 depicts an embodiment of a portion of a heterogeneous transceiver including a thin film lithium-containing transmitter integrated circuit.

FIG. 7 depicts an embodiment of a portion of a heterogeneous transceiver including a thin film lithium-containing transmitter integrated circuit.

FIG. 8 is a flow chart depicting an embodiment of a method for providing a heterogeneous transceiver including a thin film lithium-containing transmitter integrated circuit.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Typically, a heterogeneous photonics integrated circuit (PIC) is used in conjunction with an electronic IC (EIC) to provide a transceiver. The heterogeneous PIC typically includes a silicon photonics base, a photonics transmitter portion, and a photonics receiver portion. The photonics receiver portion (e.g., an optical receiver) performs light detection (e.g. via a photodiode) and conversion from an optical signal to an electrical signal. Thus, materials such as Si, SiGe, Ge, and InGaAs (which detect light over various wavelength ranges) are typically used in the photonics receiver portion of the heterogeneous PIC. The transmitter portion of the heterogeneous PIC may also include semiconductor materials. For example, silicon photonics modulators or modulated vertical cavity surface emitting lasers (VCSELs) may be used. More recently, other materials, such as lithium niobate, may be used in the photonics transmitter portion of the heterogeneous PIC. However, the photonics transmitter portion is still integrated with the photonics receiver portion, typically on a semiconductor (e.g. Si) base. Thus, a heterogenous integrated circuit is used.

For a heterogeneous PIC, the optical input/output is via optical fibers coupled to the transmitter and receiver portions via a fiber array connector. The optical fibers that receive optical signals and the optical fibers that send (transmit) optical signals are typically interleaved. Similarly, the receiver and transmitter electronics in the EIC that connect to the heterogeneous PIC are typically interleaved. For example, the signal processor used in providing a signal to modulate the light for the photonics transmitter portion may be interleaved with (e.g. in close proximity to and/or has components mixed with) electronics for the received electrical signal from the photonics receiver. Thus, the EIC and heterogenous PIC may be tightly integrated and designed together.

Integration in the heterogeneous PIC provides multiple complementary functions that might not be possible using a single material system. It is also traditionally believed that heterogeneous integration reduces cost and allows for more compact systems while maintaining performance. However, for materials such as lithium niobate, different processing techniques may be used in order to optimize performance than for materials such as silicon. Such techniques may be incompatible with semiconductor processing for the silicon photonics base and/or the receiver portion of the heterogeneous PIC. Further, lithium may be considered a contaminant for semiconductor processing. Consequently, improvements are still desired for optical transceivers.

A transceiver including an electronics integrated circuit (EIC), a photonics receiver integrated circuit (photonics RIC), a photonics transmitter integrated circuit (photonics TIC), and an interposer. The photonics RIC and TIC are each electrically coupled with the EIC. The photonics TIC is separate from the photonics RIC and includes at least one optical structure having a thin film lithium-containing (TFLC) electro-optic material. For example, thin film lithium niobate (TFLN) and/or thin film lithium tantalate (TFLT) might be used. In some embodiments, the RIC includes at least one of III-V material(s), Si, or Ge. The interposer is coupled with the EIC, the photonics RIC, and the photonics TIC. The interposer is configured to route electrical and/or optical signals between at least two of the photonics RIC, the photonics TIC, or the EIC.

The photonics TIC and the photonics RIC may be configured to be coupled to separate optical fiber arrays. In some such embodiments, the EIC includes photonics RIC connections in a first region and TIC connections in a second region different from the first region.

In some embodiments, the optical structure(s) include waveguide(s) and splitter(s) including the TFLC electro-optic material. The waveguide(s) and splitter(s) have sidewalls with a short range root mean square surface roughness not exceeding ten nanometers. In some embodiments, the optical structure(s) include a waveguide. The photonics TIC may further include electrodes proximate to a portion of the waveguide. The portion of the waveguide and the electrodes are included in an optical modulator having a modulation bandwidth of at least 70 GHz, an optical loss of not more than 2 dB, and a peak-to-peak electrode voltage not exceeding three volts. In some embodiments, the electrodes include extensions having different thicknesses. In some embodiments, the electrodes are driven by a CMS voltage such that the transceiver is a driverless transceiver for transmission. The optical modulator may have a V-pi-L of less than 3V-cm. In some embodiments, light for the optical modulator is provided to the photonics TIC from off-chip of the photonics TIC.

A transceiver including an EIC, a photonics RIC, a photonics TIC, and an interposer is described. The photonics RIC is electrically coupled with the EIC and includes at least one of III-V material(s), Si, or Ge. The photonics TIC is separate from the photonics RIC and electrically coupled with the EIC. The photonics TIC includes at least one waveguide having a thin film lithium-containing (TFLC) electro-optic material and electrodes proximate to a portion of the waveguide. The portion of the waveguide and the electrodes are included in an optical modulator having a modulation bandwidth of at least 70 GHz, an optical loss of not more than 2 dB, and a peak-to-peak electrode voltage not exceeding three volts. The interposer is coupled with the EIC, the photonics RIC, and the photonics TIC. The interposer is configured to route at least one of electrical or optical signals between at least two of the photonics RIC, the photonics TIC, or the EIC. The photonics TIC and the photonics RIC are configured to be coupled to separate optical fiber arrays.

A method is described. The method includes providing the photonics RIC and providing the photonics TIC. The photonics TIC is separate from the photonics RIC and includes at least one optical structure having a thin film lithium-containing (TFLC) electro-optic material. The method also includes coupling the photonics RIC, the photonics TIC and an EIC with an interposer. The interposer is configured to route electrical and/or optical signals between at least two of the photonics RIC, the photonics TIC, or the EIC.

The photonics RIC may include at least one of III-V material(s), Si, or Ge. The photonics TIC and the photonics RIC may be configured to be coupled to separate optical fiber arrays. In some such embodiments, the EIC includes photonics RIC connections in a first region and TIC connections in a second region different from the first region. In some embodiments, providing the photonics TIC includes providing the optical structure(s) including waveguide(s) and splitter(s) including the TFLC electro-optic material such that the waveguide(s) and the splitter(s) have sidewalls having a short range root mean square surface roughness not exceeding ten nanometers. In some embodiments, the optical structure includes a waveguide. In such embodiment, providing the photonics TIC further includes providing electrodes proximate to a portion of the waveguide. The portion of the waveguide and the electrodes are included in an optical modulator having a modulation bandwidth of at least 70 GHz, an optical loss of not more than 2 dB, and a peak-to-peak electrode voltage not exceeding three volts. The electrodes may include extensions having multiple thicknesses. The electrodes may be driven by a CMS voltage such that the transceiver is a driverless transceiver for transmission. The optical modulator may have a V-pi-L of less than 3V-cm.

Various features of the electro-optic devices are described herein. One or more of these features may be combined in manners not explicitly described herein. The optical devices described herein may be formed using electro-optic materials, such as thin film lithium containing (TFLC) electro-optical materials. For example, thin film lithium niobate (TFLN) and/or thin film lithium tantalate (TFLT) may be used for components described. Although primarily described in the context of TFLC electro-optic materials, such as TFLN and TFLT, other nonlinear optical materials may be used in the optical devices described herein. For example, other ferroelectric nonlinear (e.g. second order) optical materials may also be desired to be used in, e.g., waveguides, modulators, polarization rotators, and/or mode converters. Such ferroelectric nonlinear optical materials may include but are not limited to potassium niobate (e.g. KNbO₃), gallium arsenide (GaAs), potassium titanyl phosphate (KTP), lead zirconate titanate (PZT), and barium titanate (BaTiO₃). The techniques described may also be used for other nonlinear ferroelectric optical materials, particularly those which may otherwise be challenging to fabricate. For example, such nonlinear ferroelectric optical materials may have inert chemical etching reactions using conventional etching chemicals such as fluorine, chlorine or bromine compounds.

In some embodiments, the optical material(s) used are nonlinear. As used herein, a nonlinear optical material exhibits the electro-optic effect and has an effect that is at least (e.g. greater than or equal to) 5 picometer/volt. In some embodiments, the nonlinear optical material has an effect that is at least 10 picometer/volt. In some such embodiments nonlinear optical material has an effect of at least 20 picometer/volt. The nonlinear optical material experiences a change in index of refraction in response to an applied electric field. In some embodiments, the nonlinear optical material is ferroelectric. In some embodiments, the electro-optic material effect includes a change in index of refraction in an applied electric field due to the Pockels effect. Thus, in some embodiments, optical materials possessing the electro-optic effect in one or more the ranges described herein are considered nonlinear optical materials regardless of whether the effect is linearly or nonlinearly dependent on the applied electric field. The nonlinear optical material may be a non-centrosymmetric material. Therefore, the nonlinear optical material may be piezoelectric. Such nonlinear optical materials may have inert chemical etching reactions for conventional etching using chemicals such as fluorine, chlorine or bromine compounds. In some embodiments, the nonlinear optical material(s) include one or more of LN, LT, potassium niobate, gallium arsenide, potassium titanyl phosphate, lead zirconate titanate, and barium titanate. In other embodiments, other nonlinear optical materials having analogous optical characteristics may be used.

In some embodiments, waveguides and other structures described herein are low optical loss optical structures. For example, a waveguide may have a total optical loss of not more than 10 dB through the portion of waveguide (e.g. when biased at maximum transmission and as a maximum loss) in proximity to electrodes used in modulating the optical signal. The total optical loss is the optical loss in a waveguide through a single continuous electrode region (e.g. as opposed to multiple devices cascaded together). In some embodiments, the waveguide has a total optical loss of not more than 8 dB. In some embodiments, the total optical loss is not more than 4 dB. In some embodiments, the total optical loss is less than 3 dB. In some embodiments, the total optical loss is less than 2 dB. In some embodiments, the waveguide has an optical loss of not more than 3 dB/cm (e.g. on average). In some embodiments, the nonlinear material(s) in the waveguides has an optical loss of not more than 2.0 dB/cm. In some such embodiments, the waveguide has an optical loss of not more than 1.0 dB/cm. In some embodiments, the waveguide has an optical loss of not more than 0.5 dB/cm. In some embodiments, the low optical losses are associated with a low surface roughness of the side walls of the waveguides.

The waveguides and other optical structures may have improved surface roughness. For example, the short range root mean square surface roughness of a sidewall of the rib may be less than ten nanometers. In some embodiments, this root mean square surface roughness is not more than five nanometers. In some cases, the short range root mean square surface roughness does not exceed two nanometers. In some embodiments, a waveguide includes a rib portion and a slab portion. The height of such a rib portion is selected to provide a confinement of the optical mode such that there is a 10 dB reduction in intensity from the intensity at the center of the rib at ten micrometers from the center of the rib. For example, the height of the rib is on the order of a few hundred nanometers in some cases. However, other heights are possible in other embodiments. Various other optical components may be incorporated into the waveguide to provide the desired functionality. For example, the waveguide may have wider portion(s) for accommodating multiple modes or performing other functions.

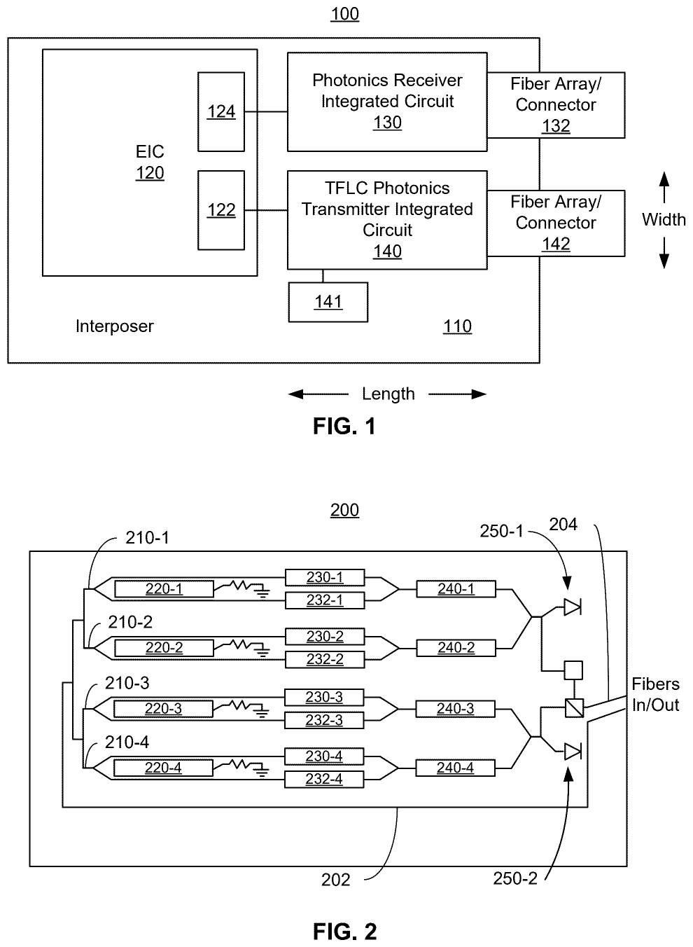

FIG. 1 depicts an embodiment of heterogeneous transceiver 100. FIG. 1 is not to scale. For clarity, only some components are shown. Transceiver 100 includes electronics integrated circuit (EIC) 120, photonics receiver integrated circuit (photonics RIC) 130, and thin film lithium-containing (TFLC) photonics transmitter integrated circuit (photonics TIC) 140 integrated together on interposer 110. Also shown are fiber arrays/connectors 132 and 142 and laser 141. Although a single EIC 120, photonics RIC 130, and TFLC photonics TIC 140 are shown, multiple EICs 120, multiple photonics RICs 130, and/or multiple TFLC photonics TICs 140 might be incorporated onto a single interposer 110. Heterogeneous transceiver 100 may be used to send or receive data over short distances (data communication) or long distances (telecommunication).

EIC 120 includes send electronics 122 and receive electronics 124. EIC 120 typically includes other components (not shown) and may communicate with other electronic devices (not shown). For example, EIC 120 may communicate with a GPU or CPU. Send electronics 122 are configured to operate in conjunction with TFLC photonics TIC 140. Receive electronics 124 are configured to operate in conjunction with photonics RIC 130. Send electronics 122 and receive electronics 124 may include CMOS components. For example, in some embodiments, send electronics 122 may include drivers, digital signal processor(s) (DSP(s)), and/or other components that may provide or receive a higher voltage signal. Such components may be omitted in some embodiments. For example, in some embodiments, send electronics 122 may drive TFLC photonics TIC 140 with voltages consistent with and/or using CMOS components. In such embodiments, driver(s) may be omitted.

Send electronics 122 may not be configured to operate with photonics RIC 130. Similarly, receive electronics 124 may not be configured to operate with TFLC photonics TIC 140. Some or all of send electronics 122 may be physically separated from receive electronics 124. In some embodiments, electrical connections between EIC 120 and photonics RIC 130 are physically separated from electrical connections between EIC 120 and TFLC photonics 140. However, other portions of send electronics 122 and receive electronics 124 might be interleaved. For example, transistors, resistors, and/or other electrical components for receive electronics 124 might be located in the same area as transistors, resistors, and/or other electrical components for send electronics 122 even when connectors are physically separate. Alternatively, all components of send electronics 122 may be physically separated from the components of receive electronics 124. Thus, EIC 120 may be configured to function and communicate with separate photonics RIC 130 and TFLC photonics TIC 140.

Photonics RIC 130 is electrically coupled with EIC 120. Photonics RIC 130 receives optical signals from fiber array/connector 132, converts the optical signals to electronic signals, and provides the electronic signals to EIC 120. Photonics RIC 130 thus may include material(s) such as III-V material(s), Si, and/or Ge. For example, photonics RIC 130 may be a silicon photonics RIC with Ge photodetectors. Photonics RIC 130 may include III-V vertically illuminated PD or PD arrays. Photonics RIC 130 may be a coherent receiver with integrated 90 degree optical hybrid.

TFLC photonics TIC 140 is configured to convert electrical data signals to optical data signals and output the optical data signals via fiber array/connector 142. Because TFLC photonics TIC 140 is separate from photonics RIC 130, fiber array/connector 132 is also separate from fiber array/connector 142. In some embodiments, TFLC photonics TIC 140 receives light from light source (e.g. laser) 141. Although shown as separate from TFLC photonics TIC 140, laser 141 may be integrated on (e.g. bonded on) TFLC photonics TIC 140. TFCL photonics TIC 140 may include modulators (not shown in FIG. 1) through which the light is transmitted and modulated by electrical signal from send electronics 122 of EIC 120. The modulators include or consist of TFLC modulators, such as TFLN and/or TFLT modulators. The modulators may use intensity modulation direct detection (IMDD) scheme. In some embodiments, the TIC may have IQ modulator(s) or DPIQ modulator(s) using a coherent light format. For coherent modulators, the polarization multiplexer may be integrated on chip (i.e. on the TIC). Thus, TFLC photonics TIC 140 may include waveguides, electrodes, and other components. Although not indicated in FIG. 1, TFLC photonics TIC 140 may include additional components. For example, monitor photodiodes or other components for monitoring and/or evaluating the performance may be incorporated into TFLC photonics TIC 140.

In some embodiments, TFLC photonics TIC 140 may have superior performance. For example, TFLC photonics TIC 140 may have an insertion loss of less than 2 dB in some embodiments, less than 1 dB in some embodiments, or less than 0.5 dB in some embodiments. V-pi-L for TFLC photonics TIC 140 (e.g. using LN/LT) may be less than 3 V-cm, less than 2.5 V-cm, less than 2 V-cm, less than 1.5 V-cm, less than 1 V-cm, or less than 0.7 V-cm, where the voltage is defined as Vpp (the drive voltage peak-to-peak). The peak-to-peak drive voltage may be the same value for differential and single ended driving. In some embodiments, V-pi is less than 4V, or less than 3V, or is less than 2V, or is less than 1.5V for some modulator configurations (e.g. IMDD). In some embodiments, driving voltage peak-to-peak (Vpp) is less than 3V, less than 2V, less than 1.5V, less than 1V, less than 0.8V, less than 0.5V. The driving voltage may be the same for differential or single ended. V-pi may be is less than 2V, is less than 1.5V, or is less than 1V for coherent modulators. Drive V-pi is typically greater than 0.5*V-pi and is less than 2*V-pi. In some embodiments, the drive V-pi is greater than 0.8 V-pi and less than 1.5*V-pi. The actual voltage for the driver (or other component of EIC 120 driving TFLC photonics TIC 140 may be less than 2 Vpp, less than 1.6 Vpp, or less than 1 Vpp. The modulator maybe folded. Thus, the waveguides and/or electrodes of TFLC photonics TIC 140 may include bends. The wavelength of the optical signal may be O-band (e.g. nominally 1300 nm), C-band (nominally 1500 nm) and/or L-band (nominally 1600 nm). The wavelength of the optical signal may also be in the near IR (800-1100 nm). The wavelength of the optical signal may be in the visible range (350 nm-800 nm). Thus, a variety of wavelengths may be used for TFLC photonics TIC 140. The usable wavelength bandwidth for TFLC photonics TIC 140 may be significantly larger than if a silicon photonics TIC were used.

TFLC photonics TIC 140 may also have various electrode and waveguide configurations and be fairly compact. For example, modulators of TFLC photonics TIC 140 may include differential drive electrodes or single ended electrodes. TIC modulators may include tight bending radius TFLC waveguides (e.g. a bending radius of less than 80 micrometers, less than 50 micrometers, or less than 30 micrometers). The modulators of TFLC photonics TIC 140 may include electrodes bends. The waveguides for modulators and other components may cross. The modulators might include integrated digital-to-analog conversion components, such as modulators with electrodes with disconnected signal lines (a different type of segmented electrodes). TFLC photonics TIC 140 may also utilize binary weighting for optical signal carried. A photonics DAC may be incorporated into TFLC photonics TIC 140. Such a photonics DAC may be configured to support either IMDD or coherent format. A driver may be omitted in some embodiments. Modulators of TFLC photonics TIC 140 may have total excessive (i.e. unavoidable) insertion loss less than 5 dB, less than 4 dB, less than 3 dB, or less than 2 dB. The modulators of TFLC photonics TIC 140 may have bandwidth of greater than 70 GHz, greater than 100 GHz, or greater than 130 GHz. For example, TFLC photonics TIC 140 may have a bandwidth of 130 GHz or more, less than 2 dB of insertion loss, and a Vpp (driving voltage) of not more than 3 V. The modulators of TFLC photonics TIC 140 may achieve smoothly etched TFLN/LT waveguide side walls having the surface roughnesses described herein. Crosstalk between TFLC photonics TIC 140 and photonics RIC 130 may be reduced. For example, the crosstalk losses may be, e.g. less than 30 dB, less than 40 dB, less than 50 dB, or less than 60 dB. TFLC photonics TIC 140 may have multiple channels (e.g. 4, 8, 16, 32, or more channels of direct modulation modulators using the same wavelength of light). For example at 1310 nm, TFLC photonics TIC 140 may include 4, 2×4, 4×4, 8×4, or 8×8 channels using coarse wavelength division multiplexing (CWDM) in the O band of light. TFLC photonics TIC 140 may be formed of multiple coherent IQ modulators using the same or different colors on the same integrated circuit. For example, 2×800 gbps, 4×800 gbps, 2×1.6 T, or 4×1.6 T may be provided on one TFLC photonics TIC 140. In some embodiments, these channels might be in C band, O band, and/or visible band. TFLC photonics TIC 140 and photonics RIC 130 may function at VSCEL wavelengths (800-1100 nm). Typical sizes (width×length) for TFLC photonics TIC 140 include: 4 mm×8 mm, 4 mm×10 mm, 4 mm×14 mm for IMDD, where the width is in the direction of the pitch. In some embodiments, the pitch between IMDD modulators for TFLC photonics TIC 140 may be less than 650 micrometers, less than 500 micrometers, less than 300 micrometers, less than 260 micrometers, or less than 200 micrometers. For example, for 16 channel electro-optic modulators, then the lateral size of (e.g. the shoreline that might be taken up by) TFLC photonics TIC 140 may be 8 mm if using less than 200 um pitch. The length may be less than 8 mm, less than 12 mm, or less than 14 mm. For IMDD modulation, the length of TFLC photonics TIC 140 may be greater than 12 mm, greater than 14 mm, greater than 17 mm, greater than 20 mm, or greater than 25 mm for coherent modulation. In other embodiments, the length of TFLC photonics TIC 140 may be less than 1 mm, less than 650 micrometer, less than 500 micrometer, less than 300 micrometers, less than 260 micrometers, or less than 200 micrometers.

Interposer 110 is coupled with EIC 120, photonics RIC 130, and TFLC photonics TIC 140. Interposer 110 may be a semiconductor (e.g. silicon), an organic, or other material. Interposer 110 is not only mechanically connected to EIC 120, photonics RIC 130, and TFLC photonic TIC 140, but may also be configured to route electrical and/or optical signals between two or all of photonics RIC 130, TFLC photonics TIC 140, and/or EIC 120. For example, electrical connections between send electronics 122 and TFLC photonics TIC 140 may be made through wiring/electrical connections within interposer 110. Similarly, connections between receive electronics 124 and photonics RIC 130 may be made through wiring/electrical connections within interposer 110. Similarly, optical connection between laser 141 and TFLC photonics TIC 140 might be made via interposer 110.

TFLC photonics TIC 140 may be integrated on interposer 110 in various configurations. In some embodiments, the TFLC photonics TIC 140 is integrated with interposer 110 such that the waveguide (not shown in FIG. 1), or front face of TFLC photonics TIC 140 faces up (away from interposer 110). Thus, the electrodes (not shown in FIG. 1) for TFLC photonics TIC 140 may also face away from interposer 110. The electrical connection with electronics in or on interposer 110 may be accomplished by through-silicon vias (TSVs), through glass vias (TGVs), or other techniques. In some embodiments, TFLC photonics TIC 140 is integrated with interposer 110 such that the waveguide side faces down, toward interposer 149 (backside of TFLC photonics TIC 140 faces up away from interposer 110). For example, TFLC photonics TIC 140 may be flip chip bonded to interposer 110.

Transceiver 100 may have improved performance and other benefits as compared to a conventional transceiver using an EIC and a heterogeneous PIC, which includes a receiver portion and a TFLC transmitter portion. TFLC photonics TIC 140 and photonics RIC 130 are formed using separate technologies. For example, TFLC photonics TIC 140 may use TFLN and/or TFLT photonics, while RIC 130 may use silicon photonics or III-V photonics. TFLC photonics TIC 140 and photonics RIC 130 thus use separate technology nodes. Such nodes may be different in the processes and conditions used to optimize performance. Consequently, separation of TFLC photonics TIC 140 and RIC 130 into different integrated circuits may improve performance of transmission and/or reception and simplify processing. For example, TFLC photonics TIC 140 may have low insertion losses, while RIC 130 may be optimized for optical signal detection. Further, TFLC photonics TIC 140 uses lithium, which may be considered a contaminant for processing of semiconductor RIC 130. Because they are distinct ICs, each photonics IC 130 and 140 may be separately fabricated and optimized to obtain the desired performance without adversely affecting fabrication systems. For TFLC photonics TIC 140, performance may be greatly improved and size controlled. Further, costs may still be controlled. Three integrated circuits (EIC 120, RIC 130, and TIC 140) are integrated on interposer 110 instead of two integrated circuits (for an EIC and a heterogeneous PIC having a transmitter portion and a receiver portion integrated onto a silicon base). Further, two fiber array/connectors 132 and 142 are used instead of one (for a single heterogeneous PIC). However, the cost of aligning optical fibers for two fiber array/connectors 132 and 142 may not be significantly larger than for aligning a single fiber array/connector for interleaved optical fibers. Surprisingly, fabrication costs for transceiver 100 may be lower than for the conventional EIC/heterogeneous PIC configuration. This may be due to reduced costs in separately fabricating photonics RIC 130 and TFLC photonics TIC 140 as compared to a heterogeneous PIC. Thus, the use of separate TFLC photonics TIC 140 and photonics RIC 130 may not significantly increase integration complexity, may reduce or not significantly increase cost, and may improve performance. Moreover, the possibility of potential contamination during processing (e.g. due to lithium) may be reduced or eliminated. TFLC photonics TIC 140 may still be relatively small in size, have a small pitch, and occupy a relatively small amount of shoreline (e.g. have a controlled width). Thus, performance as well as the ability to flexibly incorporate transceiver into various applications may be improved. In addition, the receive channels for photonics RIC 130 may be further separated from the transmit channels of TFLC photonics TIC 140. In optical transceiver 100, crosstalk between the send channels and the receive channels may be reduced. Although crosstalk is not currently an issue for short range data communication, it is believed that this may be an issue for higher bit rates. Consequently, higher bit rate communication may be facilitated.

FIG. 2 depicts an embodiment of TFLC photonics TIC 200 usable in a heterogeneous transceiver, such as transceiver 100. Thus, TFLC photonics TIC 200 may be used for TFLC photonics TIC 140. For clarity, not all components are shown and FIG. 2 is not to scale. TFLC photonics TIC 200 is a coherent transmitter that receives input light via waveguide 202 and outputs the signal at waveguide 204. TFLC photonics TIC 200 includes four waveguides 210-1, 210-2, 210-3, and 210-4 (collectively or generically waveguide(s) 210), multiple electrodes 220-1, 220-2, 220-3 and 220-4 (collectively or generically electrode(s) 220), phase shifts 230-1, 230-2, 230-3 and 230-4 (collectively or generically phase shift(s) 230), phase shifts 232-1, 232-2, 232-3 and 232-4 (collectively or generically phase shift(s) 232), phase shifts 240-1, 240-2, 240-3 and 240-4 (collectively or generically phase shift(s) 240), and photodiodes 250-1 and 250-2 (collectively or generically photodiodes 250). Waveguides 202, 204, and 210 are TFLC waveguides having the properties described herein. Stated differently, portions of TFLC photonics TIC 200 that carry the optical signal may be formed from thin film lithium-containing electro-optic material(s) such as TFLN and/or TFLT.

Optical signals are input (e.g. via optical fibers or another mechanism) to input optical path 202 (i.e., a waveguide) that carries the optical signal and splits into waveguides 210. Each waveguide 210 includes a splitter forming two arms, each of which undergoes a phase shift 230 or 232, a combiner, and an additional phase shift 240. Electrodes 220 generate electric fields that modulate the optical signals, e.g. via the electro-optic effect. Waveguides 210 are combined to waveguide 204 for output, for example via an optical fiber or other mechanism. Also shown are optional optical taps to photodiodes 250 for monitoring the optical signals. In some embodiments, coherent transmitter 200 may include optical components such as input polarization cleaners used to provide a specific stable polarization state, dual polarization splitter(s) (if dual polarization optical signals are used), IQ modulators, or complementary ports for IQ modulators, polarization rotation splitter(s), and/or dual polarization outputs. For clarity, not all components are indicated and some may be omitted.

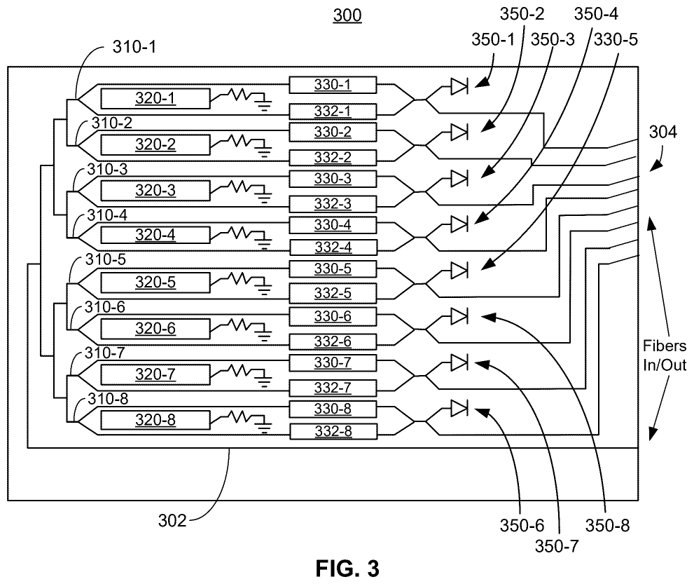

FIG. 3 depicts an embodiment of a portion of TFLC photonics TIC 300 usable in a heterogeneous transceiver, such as transceiver 100. Thus, TFLC photonics TIC 300 may be used for TFLC photonics TIC 140. For clarity, not all components are shown and FIG. 3 is not to scale. TFLC photonics TIC 300 is a DR8 (for intensity modulation direct detection/IMDD) transmitter. Although TFLC photonics TIC 300 is shown as a DR8 transmitter, another number of channels may be present. TFLC photonics TIC 300 receives input light via waveguide 302 and outputs optical signals at waveguides 304. TFLC photonics TIC 300 includes eight waveguides 310-1, 310-2, 310-3, 310-4, 310-5, 310-6, 310-7, and 310-8 (collectively or generically waveguide(s) 310), multiple electrodes 320-1, 320-2, 320-3, 320-4, 320-5, 320-6, 320-7, and 320-8 (collectively or generically electrode(s) 320), phase shifts 330-1, 330-2, 330-3, 330-4, 330-5, 330-6, 330-7, and 330-8 (collectively or generically phase shift(s) 330), phase shifts 332-1, 332-2, 332-3, 332-4, 332-5, 332-6, 332-7, and 332-8 (collectively or generically phase shift(s) 232), and photodiodes 350-1, 350-2, 350-3, 350-4, 350-5, 350-6, 350-7, and 350-8 (collectively or generically photodiodes 350). Waveguides 302, 304, and 310 are TFLC waveguides having the properties described herein. Stated differently, portions of TFLC photonics TIC 300 that carry the optical signal may be formed from thin film lithium-containing electro-optic material(s) such as TFLN and/or TFLT.

Optical signals are input (e.g. via optical fibers or another mechanism) to input optical path 302 (i.e., a waveguide) that carries the optical signal and splits into waveguides 310. Each waveguide 310 includes a splitter forming two arms, each of which undergoes a phase shift 330 or 332, and a combiner. Electrodes 320 generate electric fields that modulate the optical signals, e.g. via the electro-optic effect. The arms of waveguides 310 combined and provided waveguides 304 for output, for example via an optical fiber or other mechanism. Also shown are optional optical taps to photodiodes 350 for monitoring the optical signals. In some embodiments, TFLC photonics TIC 300 may include other components such as mode converters (e.g., to convert the mode from the fiber input to the waveguide and vice versa), additional beam splitters or multiplexer/demultiplexers, other tap(s) for monitor PDs, other modulators (including electrodes), and/or a tap for each modulator or a complementary port to a monitor photodiode. For clarity, not all portions are shown and some components may be omitted.

Thus, various TFLC photonics TICs, such as TICs 200 and/or 300 may be used in heterogeneous transceivers, such as transceiver 100. As a result, the benefits described herein may be achieved in different transceivers and/or using different encoding schemes. For example, both the TFLC photonics TIC and the photonics RIC may be separately fabricated and optimized prior to integration on the interposer. Thus, fabrication of each is facilitated and performance of each photonics component may be improved. Potential contamination during processing and performance losses through the use of a single heterogeneous PIC including both a TFLC transmitter portion and a receiver portion may be avoided without incurring significant costs. Further, TFLC photonics TIC(s) 140, 200, and/or 300 may still be relatively small in size, have a short pitch, and occupy a relatively small amount of shoreline (e.g. have a controlled width). In addition, crosstalk between the send channels and the receive channels may also be reduced. Consequently, higher bit rate communication may be facilitated. Thus, performance as well as the ability to flexibly incorporate transceiver into various applications may be improved.

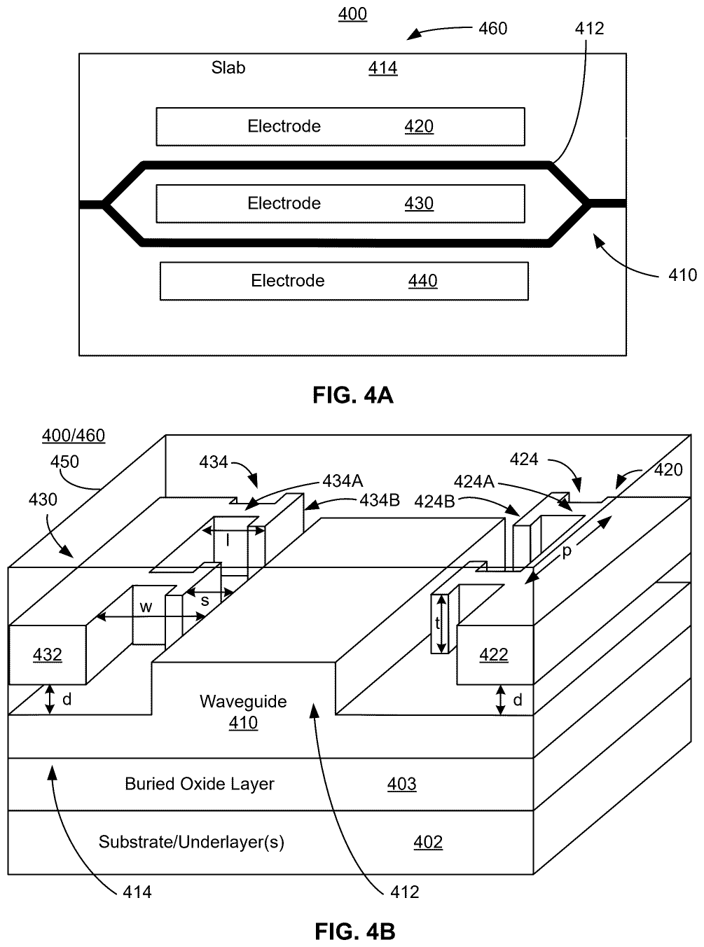

The performance of a TFLC photonics TIC, such as TFLC photonics TIC 100, 200, and/or 300, may be further optimized. In particular, design of the waveguide(s), electrode(s), and/or substrates used may improve performance. For example, FIGS. 4A-4B depict a portion of an embodiment of photonics device 400 (e.g. a TIC) using TFLC electro-optic material(s) and that may be integrated with as part of a heterogeneous transceiver. For example, photonics device 400 may be used as part or all of a modulator used in a TFLC photonics TIC such as TFLC photonics TIC(s) 140, 200, and/or 300. FIG. 4A is a top view of photonics device 400. FIG. 4B is a perspective view of a portion of photonics device 400. FIGS. 4A-4B are not to scale. Only a portion of photonics device 400 may include other and/or additional structures that are not shown for simplicity.

Photonics device 400 is on a substrate structure that includes substrate 402 and buried oxide (BOX) layer 403. In some embodiments, substrate 402 is a silicon substrate. Substrate 402 may also include other layers. In some embodiments, substrate 402 may be glass, quartz, silicon-on-insulator, and/or other low microwave loss dielectrics. Substrate 402 may be one hundred micrometers or more thick. BOX layer 403 may be a silicon dioxide layer. In some embodiments, BOX layer 403 may be at least three micrometers thick and not more than fifteen micrometers thick. In some embodiments, BOX layer 403 is not more than ten micrometers thick. In some embodiments, BOX layer 403 is at least five micrometers thick. Further, other geometric configurations of substrate 402 and/or BOX layer 403 may be used in some embodiments. Also shown is cladding 450, which may be formed of silicon dioxide.

Photonics device 400 includes waveguide 410 and electrodes 420, 430, and 440. In some embodiments, photonics device 400 may be configured as or include a modulator (or portion thereof). Thus, photonics device 400 may be considered to include a modulation region 460. Other regions, such as a bend region, may be present. Modulator 400 is shown as configured as a Mach-Zehnder modulator. Other configurations for phase and/or amplitude modulation are possible. For clarity, only the portion of electrodes 420, 430, and 440 proximate to waveguide 410 are shown. Stated differently, electrodes 420, 430, and 440 are shown in modulation region 460.

Waveguide 410 may be considered to include ridge 412 as well as slab 414. Ridge 412 has a height, t, greater than the height, t1, of slab 414. Although shown as trapezoids, ridge 412 and/or slab 414 have other shapes, such as rectangles and/or other analogous shapes. Photonics device 400 includes electro-optic optic material(s), such as TFLC materials (e.g. TFLN and/or TFLT). More specifically, ridge 412 and slab 414 include electro-optic materials, such as TFLC materials. In some embodiments, the waveguide 410 consists of TFLC materials such as TFLN and/or TFLT. In the embodiment shown, ridge 412 and slab 414 are formed of the same material. In some embodiments, ridge 412 and slab 414 may include different materials. Waveguide 410, and more particularly ridge 412, may be used to propagate the optical signal. The optical mode may be well confined to ridge 412 and/or ridge 412 in combination with a portion of nearby slab 414. Slab 414 provides increased electro-optic modulation efficiency. In particular, slab 414 aids in directing the electric field generated by the signal(s) in electrodes 420, 430, and 440 to optical mode 413 in modulation region 460. Thus, a higher modulation for a given electric field may be obtained. As a result, V-pi (and V-pi-L) may be reduced.

Electrodes 420, 430, and 440 may carry electrode signals used to modulate the optical signals (e.g. light) carried by waveguide 410 via electro-optic modulation. For example, the electrode signals may provide electro-optic modulation up to frequencies of 100 GHz, 200 GHz, 500 GHz or higher. In some embodiments, modulator 410 may provide modulation from at or near DC to frequencies of 100 GHz, 200 GHz, 500 GHz, or more. The modulation may also have a wide window, for example an operation bandwidth of at least 40 GHz. In some embodiments, modulator 410 may have an operating bandwidth of at least 30 GHz. In some embodiments, modulator 410 may have an operating bandwidth of at least 50 GHz. In some embodiments, modulator 410 may have an operating bandwidth of at least 400 GHz. In some embodiments, modulator 410 may have an operating bandwidth of at least 430 GHz. In some embodiment, modulator 410 may have a radio frequency (RF) V-pi (singled ended or differential) of at most 8V. In some embodiments, the modulator 410 may have a V-pi of at most 6V. In some embodiments, modulator 410 may have a V-pi at most 4V. In some embodiments, modulator 410 may have a V-pi of at most 3V. In some embodiments, the modulator 410 may have a V-pi of at most 2V or at most 4V.

Electrode signals carried by electrodes 420, 430, and 440 may be configured in a variety of manners. For example, electrode 430 may carry a microwave signal, while electrodes 420 and 440 are ground. Electrode 430 may carry a signal of a first polarity, while electrodes 420 and 440 carry signals of opposite polarity (i.e. in a differential configuration). Other configurations are possible.

Electrodes 420, 430, and/or 440 may include extensions. Embodiments of analogous electrodes may be found in co-pending U.S. patent application Ser. No. 17/843,906, entitled ELECTRO-OPTIC DEVICES HAVING ENGINEERED ELECTRODES, which is a continuation of U.S. patent application Ser. No. 17/102,047 entitled ELECTRO-OPTIC DEVICES HAVING ENGINEERED ELECTRODES, filed Nov. 23, 2020, which claims priority to U.S. Provisional Patent Application No. 62/941,139 entitled THIN-FILM ELECTRO-OPTIC MODULATORS filed Nov. 27, 2019, U.S. Provisional Patent Application No. 63/033,666 entitled HIGH PERFORMANCE OPTICAL MODULATORS filed Jun. 2, 2020, and U.S. Provisional Patent Application No. 63/112,867 entitled BREAKING VOLTAGE-BANDWIDTH LIMIT IN INTEGRATED LITHIUM NIOBATE MODULATORS USING MICRO-STRUCTURED ELECTRODES filed Nov. 12, 2020, all of which are incorporated herein by reference for all purposes. In other embodiments, extensions may be omitted from some or all of electrodes 420, 430, and/or 440. Electrodes 420, 430, and 440 may carry differential electrical signals, a single electrical signal (e.g. a signal and ground), or other signal(s).

FIG. 4B depicts an embodiment of a portion of photonics device 400 including TFLC materials in modulation region 460. More specifically, features that may be present in electrodes 420, 430, and/or 440 are shown. Electrode(s) 420 and/or 430 are configured to carry a traveling wave (e.g. a microwave or RF electrode signal) that modulates the optical signal carried by waveguide 410 via the electro-optic effect. Electrode 420 includes channel region 422 and extensions 424. Electrode 430 includes channel region 432 and extensions 434. In some embodiments, extensions 424 and 434 may be omitted. Substrate 402 may include silicon and/or other materials.

Electro-optic waveguide 410 is or includes a TFLC layer that may include or consist of LN and/or LT. In some embodiments, the nonlinear optical material for TFLC waveguide 410 is formed from a thin film layer. For example, the thin film may have a total thickness (e.g. of thin film or slab portion 414 and ridge portion 412) of not more than three multiplied by the optical wavelengths for the optical signal carried in ridge 412 before processing. In some embodiments, the thin film has a total thickness of not more than two multiplied by the optical wavelengths. In some embodiments, the nonlinear optical material has a total thickness of not more than one multiplied by the optical wavelength. In some embodiments, the nonlinear optical material has a total thickness of not more than 0.5 multiplied by the optical wavelengths. For example, the thin film may have a total thickness of not more than three micrometers as-provided. In some embodiment, the thin film has a total thickness of not more than two micrometers. In some embodiment, the thin film has a total thickness of not more than one micrometer as-provided. In some embodiments, the thin film has a total thickness of not more than seven hundred nanometers. In some such embodiments, the thin film has a total thickness of not more than four hundred nanometers. In some embodiments, the thin film has a thickness of at least one hundred nanometers as-provided.

The thin film nonlinear optical material may be fabricated into waveguide 410 utilizing photolithography. For example, ultraviolet (UV) and/or deep ultraviolet (DUV) photolithography may be used to pattern masks for the nonlinear optical material. For DUV photolithography, the wavelength of light used is typically less than two hundred and fifty nanometers. To fabricate the waveguide, the thin film nonlinear optical material may undergo a physical etch, for example using dry etching, reactive ion etching (RIE), inductively coupled plasma RIE. In some embodiments, a chemical etch and/or electron beam etch may be used. Ridge 412 may thus have improved surface roughness. For example, the sidewall(s) of ridge 412 may have reduced surface roughness. For example, the short range root mean square surface roughness of a sidewall of the ridge 412 is less than ten nanometers. In some embodiments, this root mean square surface roughness is not more than five nanometers. In some cases, the short range root mean square surface roughness does not exceed two nanometers. In some embodiments, optical device 400B has an optical loss in signal through the modulator of not more than 4 dB/cm. In some embodiments, the optical loss is not more than 2 dB/cm. In some such embodiments, the optical loss for TFLC waveguide 410 is less than 4.0 dB/cm. For example, this loss may be not more than 0.5 dB/cm in some embodiments. In some embodiments, the height of ridge 412 is selected to provide a confinement of the optical mode such that there is a 40 dB reduction in intensity from the intensity at the center of ridge 412 at ten micrometers from the center of ridge 412. For example, the height of ridge 412, t, is on the order of a few hundred nanometers in some cases. The height of ridge 412 may be not more than three hundred nanometers. In some embodiments, the height of ridge 412 is not more than two hundred nanometers. In some embodiments, the height of ridge 412 is not more than one hundred nanometers. However, other heights are possible in other embodiments. A portion of ridge 412 is proximate to electrodes 420 and 430 along the direction of transmission of the optical signal (e.g. from the input of the optical signal through ridge 412 to the modulated optical signal output). The portion of ridge 412 proximate to electrodes 420 and 430 may have the lengths described above, for example a length greater than two millimeters in some embodiments, and greater than two or more centimeters in some such embodiments. Such lengths are possible at least in part because of the low optical losses per unit length for ridge 412 described herein. Further, the portion of ridge 412 proximate to electrodes 420 and 430 has an optical mode cross-sectional area that is small, for example not extending significantly beyond the edges of ridge 412. In some embodiments, ridge 412 has an optical mode cross-sectional area of less than the square of the wavelength of the optical signal in the nonlinear optical material(s) (e.g. 22). In some embodiments, the optical mode cross-sectional area is less than 3 multiplied by 22, where 2 is the wavelength of the optical signal in the waveguide.

Electrodes 420 and 430 apply electric fields to ridge 412. Electrode(s) 420 and/or 430 may be fabricated using deposition techniques, such as electroplating, and photolithography to shape the electrode(s) 120 and/or 430. The resulting electrode(s) 420 and/or 430 may have a lower frequency dependent electrode loss, in the ranges described herein. Electrode 420 includes a channel region 422 and extensions 424 (of which only one is labeled in FIG. 4B). Electrode 430 includes a channel region 432 and extensions 434 (of which only one is labeled in FIG. 4B). In some embodiments, extensions 424 or 434 may be omitted from electrode 420 or electrode 430, respectively. Extensions 424 and 434 are closer to ridge 412 than channel region 422 and 432, respectively, are. For example, the distance s from extensions 424 and 434 to waveguide ridge 412 is less than the distance w from channels 422 and 432 to waveguide ridge 412. In the embodiment shown in FIG. 4B, extensions 424 and 434 are at substantially the same level as channel regions 422 and 432, respectively. In some embodiments, the extensions may protrude above and/or below the channel regions in addition to or in lieu of being at the same level. Further, if electrodes 420 and 430 are above ridge 412, extensions 424 and 434 may extend over the top of ridge 412. Stated differently, extensions 424 and 434 may be closer than the width of ridge 412.

Extensions 424 and 434 are in proximity to ridge 412. For example, extensions 424 and 434 are a vertical distance, d from TFLC waveguide 410. The vertical distance to TFLC waveguide 410 may depend upon the cladding 450 (not shown in FIG. 4B) used. The distance d is highly customizable in some cases. For example, d may range from zero (or less if electrodes 420 and 430 contact or are embedded in slab portion 414) to greater than the height of ridge 412. However, d is generally still desired to be sufficiently small that electrodes 420 and 430 can apply the desired electric field to ridge 412. Extensions 424 and 434 are also a distance, s, from ridge 412. Extensions 424 and 434 are desired to be sufficiently close to TFLC waveguide 410 (e.g. close to ridge 412) that the desired electric field and index of refraction change can be achieved. However, extensions 424 and 434 are desired to be sufficiently far from TFLC waveguide 410 (e.g. from ridge 412) that their presence does not result in undue optical losses. Although the distance s is generally agnostic to specific geometry or thickness of TFLC waveguide 410, s may be selected to allow for both transverse electric and transverse optical modes that are confined differently in TFLC waveguide 410. However, the optical field intensity at extensions 424 and 434 (and more particularly at sections 424B and 434B) is desired to be reduced to limit optical losses due to absorption of the optical field by the conductors in extensions 424 and 434. Thus, s and/or d are sufficiently large that the total optical loss for ridge 412, including losses due to absorption at extensions 424 and 434, is not more than 40 dB or less in some embodiments, 4 dB or less in some embodiments, and/or 4 dB or less in some embodiments. In some embodiments, s is selected so that optical field intensity at extensions 424 and 434 is less than −10 dB of the maximum optical field intensity in ridge 412. In some embodiments, s is chosen such that the optical field intensity at extensions 424 and 434 is less than −40 dB of its maximum value in the waveguide. For example, extensions 424 and/or 434 may be at least two micrometers and not more than 2.5 micrometers from ridge 412 in some embodiments. In some embodiments, extensions 424 and/or 434 may extend over ridge 412 if d is greater than the height of the ridge for ridge 412.

In the embodiment shown, extensions 424 have a connecting portion 424A and a retrograde portion 424B. Retrograde portion 424B is so named because a part of retrograde portion may be antiparallel to the direction of signal transmission through electrode 420. Similarly, extensions 434 have a connecting portion 434A and a retrograde portion 434B. Thus, extensions 424 and 434 have a “T”-shape. In some embodiments, other shapes are possible. For example, extensions 424 and/or 434 may have an “L”-shape, may omit the retrograde portion, may be rectangular, trapezoidal, parallelogram-shaped, may partially or fully wrap around a portion of ridge 412, and/or have another shape. Similarly, channel regions 422 and/or 432, which are shown as having a rectangular cross-section, may have another shape. Further, extensions 424 and/or 434 may be different sizes. Although all extensions 424 and 434 are shown as the same distance from ridge 412, some of extensions 424 and/or some of extensions 434 may be different distances from ridge 412. Channel regions 422 and/or 432 may also have a varying size. In some embodiments, extensions 424 and 434, respectively, are desired to have a length, l (e.g. l=w−s), that corresponds to a frequency less than the Bragg frequency of the signal for electrodes 420 and 430, respectively. Thus, the length of extensions 424 and 434 may be desired to be not more than the microwave wavelength of the electrode signal divided by π at the highest frequency of operation for electrodes 420 and 430. In some embodiments, the length of extensions 424 and 434 is desired to be less than the microwave wavelength divided by twelve. For example, if the maximum operation frequency is 300 GHz, which corresponds to a microwave wavelength of 440 micrometers in the substrate, extensions 424 and 434 are desired to be smaller than approximately 37 micrometers. Individual extensions 424 and/or 434 may be irregularly spaced or may be periodic. Periodic extensions have a constant pitch. In some embodiments, the pitch, p, is desired to be a distance corresponding to a frequency that is less than the Bragg frequency, as discussed above with respect to the length of extensions 424 and 434. Thus, the pitch for extensions 424 and 434 may be desired to be not more than the microwave wavelength of the electrode signal divided by x at the highest frequency of operation for electrodes 420 and 430. In some embodiments, the pitch is desired to be less than the microwave wavelength divided by twelve. In some embodiments, the pitch is desired to be less than the microwave wavelength divided by seventy two, allowing for a low ripple in group velocity.

Also indicated in FIG. 4B is thickness, t, of extensions 424 and 434. In the embodiment shown, channels 422 and 432 have the same thickness. In some embodiments, the thickness of extensions 424 and/or 434 may vary. For example, extensions 424 may be thinner (or thicker) than extensions 434. Further, different extensions 424 may have different thicknesses. Similarly, different extensions 434 may have different thicknesses. Extensions 424 and/or 434 may also have a different thickness than channels 422 and/or 432. For example, extensions 424 and/or 434 may be thinner (or thicker) than channels 422 and/or 432. Different portions of extensions 424 and/or 434 may also have different thicknesses. For example, retrograde portions 424B and/or 434B may be thinner (or thicker) than connecting portions 424A and/or 434B.

Extensions 424 and 434 are closer to ridge 412 than channels 422 and 432, respectively, are (e.g. s<w). In some embodiments, a dielectric cladding 450 (not explicitly shown in FIG. 4B) resides between electrodes 420 and 430 and TFLC waveguide 410. As discussed above, extensions 424 and 434 are desired to have a length (w−s) that corresponds to a frequency less than the Bragg frequency of the signal for electrodes 420 and 430, respectively. Extensions 424 and 434 are also desired to be spaced apart from ridge 412 as indicated above (e.g. such that the absorption loss in ridge 412 can be maintained at the desired level, such as 40 dB or less). The length of the extensions 424 and 434 and desired separation from ridge 412 (e.g. s) are considered in determining w. Although described in the context of a horizontal distance, the distance between electrode structures and the waveguide also applies for vertical configurations. Other distances between ridge 412 and channel regions 422 and/or 432 are possible.

Extensions 424 and 434 protrude from channel regions 422 and 432, respectively, and reside between channel regions 422 and 432, respectively, and waveguide 400. As a result, extensions 424 and 434 are sufficiently close to waveguide 400 to provide an enhanced electric field at waveguide 400. Consequently, the change in index of refraction induced by the electric field is increased. In contrast, channel regions 422 and 432 are spaced further from waveguide 400 than the extensions 424 and 434. Thus, channel region 422 is less affected by the electric field generated by electrode 430/extensions 434. Electrical charges have a reduced tendency to cluster at the edge of channel region 422 closest to electrode 430. Consequently, current is more readily driven through central portions channel region 422 and the electrode losses in channel region 422 (and electrode 420) may be reduced. Because microwave signal losses through electrodes 420 and 430 may be reduced, a smaller driving voltage may be utilized for electrode(s) 420 and/or 430 and less power may be consumed by optical device 400. In addition, the ability to match the impedance of electrode 420 with an input voltage device (not shown) may be improved. Such an impedance matching may further reduce electrode signal losses for optical device 400. Moreover, extensions 424 and 434 may affect the speed of the electrode signal through electrodes 420 and 430. Thus, extensions 424 and 434 may be configured to adjust the velocity of the electrode signal to match the velocity of the optical signal in waveguide 400. Consequently, performance of optical device 400 may be improved. Performance of the TFLC photonics TIC and transceiver in which device 400 is used may thus be enhanced.

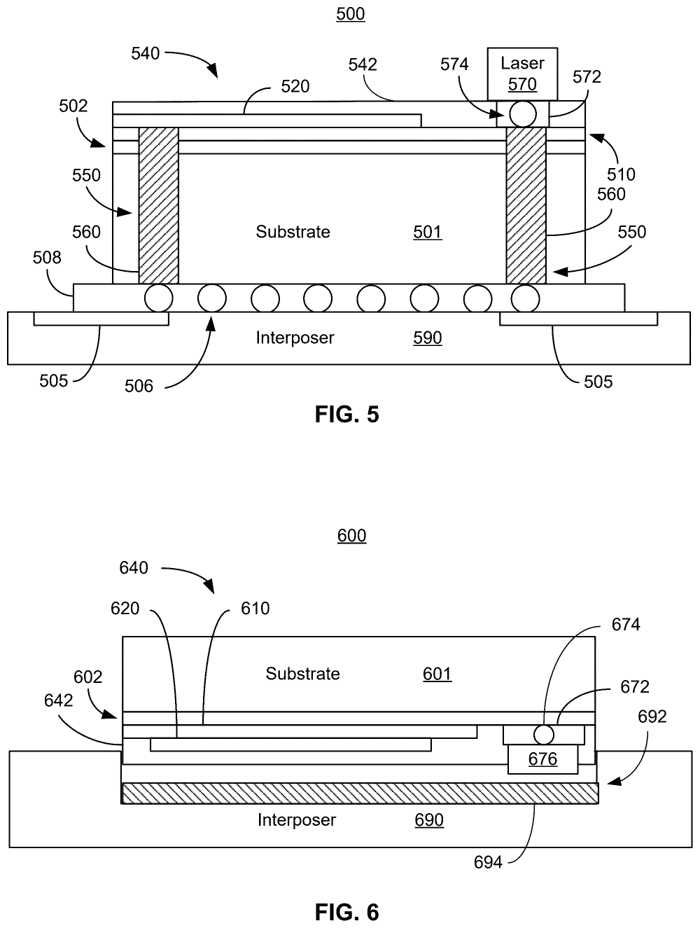

FIG. 5 depicts an embodiment of a portion of heterogeneous transceiver 500 including TFLC photonics TIC 540. Transceiver 500 includes TFLC photonics TIC 540 and interposer 590 that are analogous to TFLC photonics TIC 140, 200, and/or 300 and interposer 110. For clarity, not all components are shown and FIG. 5 is not to scale.

Interposer 590 includes conductive pads 505 and is mechanically coupled with TFLC photonics TIC 540 via underfill 508. Electrical connection is made via solder bumps 506. In other embodiments, other mechanisms may be used to provide electrical and/or mechanical connection between TFLC photonics TIC 540 and interposer 590. Additional electronics, such as metallization, passive components, and/or active components, may be within interposer 590 but are not shown.

TFLC photonics TIC 540 includes TFLC layer 510, electrodes 520, cladding 542, and a substrate structure including substrate 501 and BOX layer 502 that are analogous to TFLC layer/waveguide 410, electrodes 420, cladding 450, substrate 402, and BOX layer 403, respectively. Thus, electro-optic layer 510 includes one or more TFLC materials, such as TFLN and/or TFLT. In some embodiments, other electro-optic material(s) may be used may be used in addition to or in lieu of TFLC material(s). Although described as a layer, TFLC layer 510 may include multiple layers. Optical components, such as waveguide(s), are formed in TFLC layer 510. For simplicity, not all components are shown. For example, additional electrodes, an EIC (e.g., analogous to EIC 120), and photonics RIC (e.g., analogous to photonics RIC 130) are not shown.

TFLC photonics TIC 540 also includes vias 550 having conductive fill 560. Although not shown, one or more of vias 550 may include a dielectric coating. In some embodiments, vias 550 are through-silicon vias (TSVs) or through-glass vias (TGVs). Although two vias 550 having particular locations are shown, another (e.g., larger) number of vias are generally present and may be located as desired for TFLC photonics TIC 540. Vias 550 extend through not only substrate 501, but also BOX layer 502 and TFLC layer 510. Further, vias 550 may be formed in an analogous manner to vias 150 and/or 150′. TFLC photonics TIC 540 also includes conductive filler 572 and solder bump 574. In the embodiment shown, filler 572 and solder bump 574 may be used to provide mechanical and electrical connection to laser 570. Thus, through solder bump 506, via conductive filler 560, and solder bump 574, connection may be made between interposer 590 (i.e. pad 505) and laser 570. In some embodiments, other pads may be used to connect to other devices, such as photodiode(s) and/or driver(s) (where present). In addition, electrical connection is made to electrode 520. Thus, electrode 520 that is used to modulate the optical signal in TFLC layer 510 may be driven by electrical connections in interposer 590.

For transceiver 500, TFLC photonics TIC 540 is integrated with interposer 590 such that the waveguide(s) of TFLC layer 510, or the front face of TFLC photonics TIC 540 faces up (away from interposer 590). Thus, the electrodes, including electrode 520, for TFLC photonics TIC 540 may also face away from interposer 110. The electrical connection with electronics in or on interposer 590 is accomplished by conductive filler 560 in vias 550. The substrate 501 may be silicon, glass, quart, silicon-on-insulator and or other low microwave loss dielectrics. In some embodiments, substrate 501 may have a material absorption coefficient of less than 0.01. Similarly, cladding 542 on electrode 520 may be a low loss dielectric cladding (e.g., having a microwave loss coefficient of less than 0.05). A top dielectric (not separately shown) may be air, oxides, and/or polymers including polyimide. Although laser 570 is shown as mounted on TFLC photonics TIC 540, in some embodiments, laser 570 may be elsewhere. For example, laser 570 may be on interposer 590. In some embodiments, other components may be mounted on TFLC photonics TIC 540. For example, monitor photodiode(s) may be integrated or bonded on top of TFLC photonics TIC 540.

Thus, transceiver 500 may have a separate TFLC photonics TIC 540, EIC (not shown), and photonics RIC (not shown). Consequently, the benefits described herein may be achieved.

FIG. 6 depicts an embodiment of a portion of heterogeneous transceiver 600 including TFLC photonics TIC 640. Transceiver 600 includes TFLC photonics TIC 640 and interposer 690 that are analogous to TFLC photonics TIC 140, 200, 300, and/or 540 and interposer 110 and/or 590. For clarity, not all components are shown and FIG. 6 is not to scale.

TFLC photonics TIC 640 includes TFLC layer 610, electrodes 620, cladding 642, and a substrate structure including substrate 601 and BOX layer 602 that are analogous to TFLC layer/waveguide 410, electrodes 420, cladding 450, substrate 402, and BOX layer 403, respectively. Thus, electro-optic layer 610 includes one or more TFLC materials, such as TFLN and/or TFLT. In some embodiments, other electro-optic material(s) may be used may be used in addition to or in lieu of TFLC material(s). Although described as a layer, TFLC layer 610 may include multiple layers. Optical components, such as waveguide(s), are formed in TFLC layer 610. For simplicity, not all components are shown. For example, additional electrodes, an EIC (e.g., analogous to EIC 120), and photonics RIC (e.g., analogous to photonics RIC 130) are not shown.

Interposer 690 includes cavity 692 and underfill 694. Although not shown, interposer 690 may also include conductive pads, additional electronics, such as metallization, passive components, and/or active components. Thus, interposer 690 may be used to mechanically and electrically connect to TFLC photonics TIC 640.

For transceiver 600, TFLC photonics TIC 640 is integrated with interposer 690 such that the waveguide(s) of TFLC layer 610, or the front face of TFLC photonics TIC 640 faces down (toward interposer 690). TFLC photonics TIC 540 may be viewed as being flip-chip mounted to interposer 590. In the embodiment shown, TFLC photonics TIC 640 is mounted in recess 692. However, in some embodiments, recess 692 may be omitted. Thus, TFLC photonics TIC 640 may be mounted on a top (flat) surface of interposer 690. In such embodiments, underfill 694 contacts the front surface of TFLC photonics TIC 640. Underfill 694 may be low loss dielectric (e.g., having a microwave loss coefficient of less 0.05). In the embodiment shown, underfill 694 occupies only a portion of cavity 692. In some embodiments, underfill 694 may be omitted. Stated differently, some or all of underfill 694 may be air. Cladding 642 may be a thick low RF loss dielectric (e.g., oxide(s)) and may be analogous to cladding 542.

Also shown is monitor photodiode 676 coupled to TFLC photonics TIC 640 by underfill 672 and solder bump 674. Photodiode 672 may be integrated on top of TFLC photonics TIC 640 initially, but faces down (toward interposer 690) after flip chip bonding. A recess in the interposer maybe needed to accommodate the photodiode 672 if TFLC photonics TIC 640 is mounted on the top (flat) surface of interposer 690. If recess 692 is used, then sufficient room for photodiode 676 (or an additional recess) is desired. In both cases, photodiode 676 may be integrated through heterogeneous integration on the TFLN/TFLT platform.

Thus, transceiver 600 may have a separate TFLC photonics TIC 640, EIC (not shown), and photonics RIC (not shown). Consequently, the benefits described herein may be achieved.

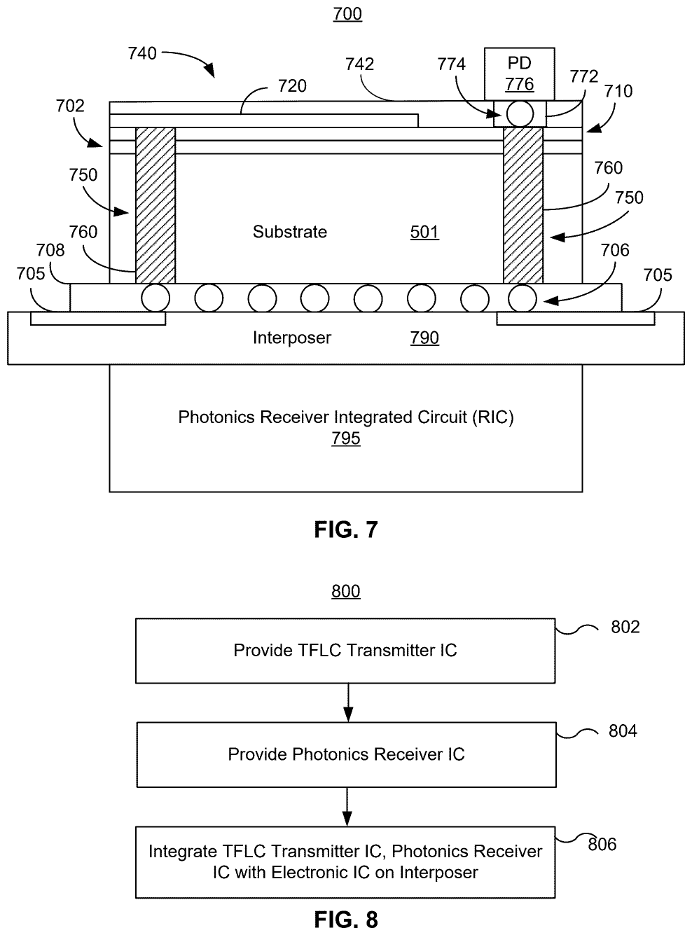

FIG. 7 depicts an embodiment of a portion of heterogeneous transceiver 700 including TFLC photonics TIC 740. Transceiver 700 includes TFLC photonics TIC 740 and interposer 790 that are analogous to TFLC photonics TIC 140, 200, 300, 500, and/or 600 and interposer 110, 590, AND/OR 690. For clarity, not all components are shown and FIG. 7 is not to scale.

Transceiver 700 is analogous to transceiver 500 and includes analogous components. Thus, transceiver 700 includes TFLC photonics TIC 740 and interposer 790 analogous to TFLC photonics TIC 540 and interposer 590. Interposer 790 includes conductive pads 705 and is coupled to TFLC photonics TIC 740 via underfill 708 and solder bumps 706 that are analogous to pads 505, solder bumps 506, and underfill 508. TFLC photonics TIC 740 includes TFLC layer 710, electrodes 720, cladding 742, vias 750, conductive filler 760, and a substrate structure including substrate 701 and BOX layer 702 that are analogous to TFLC layer/waveguide 410/510, electrodes 420/520, cladding 450/542, vias 550, conductive filler 560, substrate 402/501, and BOX layer 403/502, respectively. For simplicity, not all components are shown. Photodiode 776 analogous to photodiode 676 is also shown. Photodiode 776 is mechanically and electrically coupled with TFLC photonics TIC 740 via underfill 772 and solder bump 774. For example, additional electrodes, a laser, and photonics RIC (e.g., analogous to photonics RIC 130) are not shown.

Transceiver 700 also includes RIC 795 analogous to photonics RIC 130. In the embodiments shown, TFLC photonics TIC 740 and photonics RIC 795 are integrated on opposite sides of interposer 790. In some embodiments, interposer 790 may contain part of or all of the intended functionality of the EIC 120. In other embodiments, an EIC analogous to EIC 120 may be integrated with interposer 790.

Thus, transceiver 700 may have a separate TFLC photonics TIC 740, EIC (not shown), and photonics RIC 795. Consequently, the benefits described herein may be achieved.

FIG. 8 is a flow chart depicting an embodiment of method 800 for providing a heterogeneous transceiver including a TFLC photonics TIC that is separate from the RIC. Method 800 is described in the context of processes that may have sub-processes. Although described in a particular order, another order not inconsistent with the description herein may be utilized. For example, in some embodiments, portions of processes may be interleaved. Method 800 is also described in the context of heterogeneous transceiver 100. However, method 800 may be used with other electro-optic devices including but not limited to transceivers 500, 600, and/or 700 and TFLC photonics TICs 200, 300, and/or 400.

A TFLC photonics TIC is provided, at 802. In some embodiments, 802 includes fabricating the TFLC photonics TIC. In some embodiments, the TFLC photonics TIC may be purchased or otherwise obtained. At 804, a photonics RIC is provided. In some embodiments, 804 includes fabricating the photonics RIC. In some embodiments, 804 includes purchasing or otherwise obtaining the photonics RIC. The TFLC photonics TIC provided at 802 is the separate from the photonics RIC provided at 804. Thus, a single heterogeneous PIC is not utilized.

The photonics RIC is coupled with the photonics TIC and an EIC via an interposer, at 806. The interposer is configured to route electrical and/or optical signals between at least two of the photonics RIC, the photonics TIC, or the EIC. In some embodiments, the EIC and interposer may form a single component.

For example, TFLC photonics TIC 140 is provided, at 802. TFLC photonics TIC 130 may thus be fabricated or obtained. At 804, photonics RIC 130 is provided. Thus, photonics RIC 130 is fabricated or obtained. At 806, TFLC photonics TIC 140, photonics RIC 130, and EIC 120 are coupled with interposer 110. Thus, the benefits of heterogeneous transceivers 100, 500, 600, and/or 700 may be achieved.

Although the foregoing embodiments have been described in some detail for purposes of clarity of understanding, the invention is not limited to the details provided. There are many alternative ways of implementing the invention. The disclosed embodiments are illustrative and not restrictive.

1. A transceiver, comprising:
an electronics integrated circuit (EIC);
a photonics receiver integrated circuit (photonics RIC) electrically coupled with the EIC;
a photonics transmitter integrated circuit (photonics TIC) separate from the photonics RIC and electrically coupled with the EIC, the photonics TIC including at least one optical structure having a thin film lithium-containing (TFLC) electro-optic material; and
an interposer coupled with the EIC, the photonics RIC, and the photonics TIC, the interposer being configured to route at least one of electrical or optical signals between at least two of the photonics RIC, the photonics TIC, or the EIC.

2. The transceiver of claim 1, wherein the photonics RIC includes at least one of III-V material(s), Si, or Ge.

3. The transceiver of claim 1, wherein the photonics TIC and the photonics RIC are configured to be coupled to separate optical fiber arrays.

4. The transceiver of claim 3, wherein the EIC includes photonics RIC connections in a first region and TIC connections in a second region different from the first region.

5. The transceiver of claim 1, wherein the at least one optical structure includes at least one waveguide and at least one splitter including the TFLC electro-optic material, the waveguide and the splitter having sidewalls having a short range root mean square surface roughness not exceeding ten nanometers.

6. The transceiver of claim 1, wherein the at least one optical structure includes a waveguide, the photonics TIC further comprising:
a plurality of electrodes proximate to a portion of the waveguide, the portion of the waveguide and the plurality of electrodes being included in an optical modulator having a modulation bandwidth of at least 70 GHz, an optical loss of not more than 2 dB, and a peak-to-peak electrode voltage not exceeding three volts.

7. The transceiver of claim 6, wherein the plurality of electrodes includes a plurality of extensions having a plurality thicknesses.

8. The transceiver of claim 6, wherein the plurality of electrodes are driven by a CMOS voltage such that the transceiver is a driverless transceiver for transmission.

9. The transceiver of claim 6, wherein the optical modulator has a V-pi-L of less than 3V-cm.

10. The transceiver of claim 6, wherein light for the optical modulator is provided to the photonics TIC from off-chip of the photonics TIC.

11. A transceiver, comprising:
an electronics integrated circuit (EIC);
a photonics receiver integrated circuit (photonics RIC) electrically coupled with the EIC, the photonics RIC including at least one of III-V material(s), Si, or Ge;
a photonics transmitter integrated circuit (photonics TIC) separate from the photonics RIC and electrically coupled with the EIC, the photonics TIC including at least one waveguide having a thin film lithium-containing (TFLC) electro-optic material and a plurality of electrodes proximate to a portion of the waveguide, the portion of the waveguide and the plurality of electrodes being included in an optical modulator having a modulation bandwidth of at least 70 GHz, an optical loss of not more than 2 dB, and a peak-to-peak electrode voltage not exceeding three volts; and
an interposer coupled with the EIC, the photonics RIC, and the photonics TIC, the interposer being configured to route at least one of electrical or optical signals between at least two of the photonics RIC, the photonics TIC, or the EIC;
wherein the photonics TIC and the photonics RIC are configured to be coupled to separate optical fiber arrays.

12. A method, comprising:
providing a photonics receiver integrated circuit (photonics RIC);
providing a photonics transmitter integrated circuit (photonics TIC) separate from the photonics RIC, the photonics TIC including at least one optical structure having a thin film lithium-containing (TFLC) electro-optic material; and
coupling the photonics RIC, the photonics TIC and an electronics integrated circuit (EIC) with an interposer, the interposer being configured to route at least one of electrical or optical signals between at least two of the photonics RIC, the photonics TIC, or the EIC.

13. The method of claim 12, wherein the photonics RIC includes at least one of III-V material(s), Si, or Ge.

14. The method of claim 12, wherein the photonics TIC and the photonics RIC are configured to be coupled to separate optical fiber arrays.

15. The method of claim 14, wherein the EIC includes photonics RIC connections in a first region and TIC connections in a second region different from the first region.

16. The method of claim 12, wherein providing the photonics TIC further includes:
providing the at least one optical structure including at least one waveguide and at least one splitter including the TFLC electro-optic material such that the at least one waveguide and the at least one splitter have sidewalls having a short range root mean square surface roughness not exceeding ten nanometers.

17. The method of claim 12, wherein the providing the at least one optical structure further includes a waveguide and wherein the providing the photonics TIC further includes:
providing a plurality of electrodes proximate to a portion of the waveguide, the portion of the waveguide and the plurality of electrodes being included in an optical modulator having a modulation bandwidth of at least 70 GHz, an optical loss of not more than 2 dB, and a peak-to-peak electrode voltage not exceeding three volts.

18. The method of claim 17, wherein the plurality of electrodes includes a plurality of extensions having a plurality thicknesses.

19. The method of claim 17, wherein the plurality of electrodes are driven by a CMOS voltage such that the transceiver is a driverless transceiver for transmission.

20. The method of claim 17, wherein the optical modulator has a V-pi-L of less than 3V-cm.
